(19) United States
(12) Patent Application Publication
(10) Pub. No.: US 2013/0163296 A1
(43) Pub. Date: Jun. 27, 2013

(54) POWER CIRCUIT

(71) Applicants: ZHI-YONG GAO, Wuhan City (CN); HAI-YI JI, Wuhan City (CN); YU-LIN LIU, Wuhan City (CN)

(72) Inventors: ZHI-YONG GAO, Wuhan City (CN); HAI-YI JI, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/570,694

(22) Filed: Aug. 9, 2012

(30) Foreign Application Priority Data
Dec. 21, 2011 (CN) 201110432409.7

(51) Int. Cl. H02M 1/15

(52) U.S. Cl. 363/45

(57) ABSTRACT

A power circuit includes an input terminal receiving alternating current, a first AC filtering circuit connected to the input terminal, a bridge rectifier circuit, a DC filtering circuit, a DPDT switch, and an output terminal. Two input ends of the bridge rectifier circuit are connected to the first AC filtering circuit. The DPDT switch includes a first pair of pins, a second pair of pins, and a pair of output pins. The first pair of pins is connected to the DC filtering circuit. The second pair of pins is connected to the input terminal. The DC filtering circuit is connected to the pair of output pins of the DPDT switch. The first pair of pins is switched on to enable the output terminal to output direct current, and the second pair of pins is switched on to enable the output terminal to output alternating current.

### BACKGROUND

1. Technical Field

The present disclosure relates to a power circuit.

2. Description of Related Art

A power supply is very important in a computer, and the working parameters of the power supply need to be tested during design, manufacture, and testing of the computer. There is a DC converter used in the testing of the power supply. However, when AC is needed, the power supply should be connected to AC again, which is inconvenient.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a power circuit.

FIG. 2 is a diagram circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

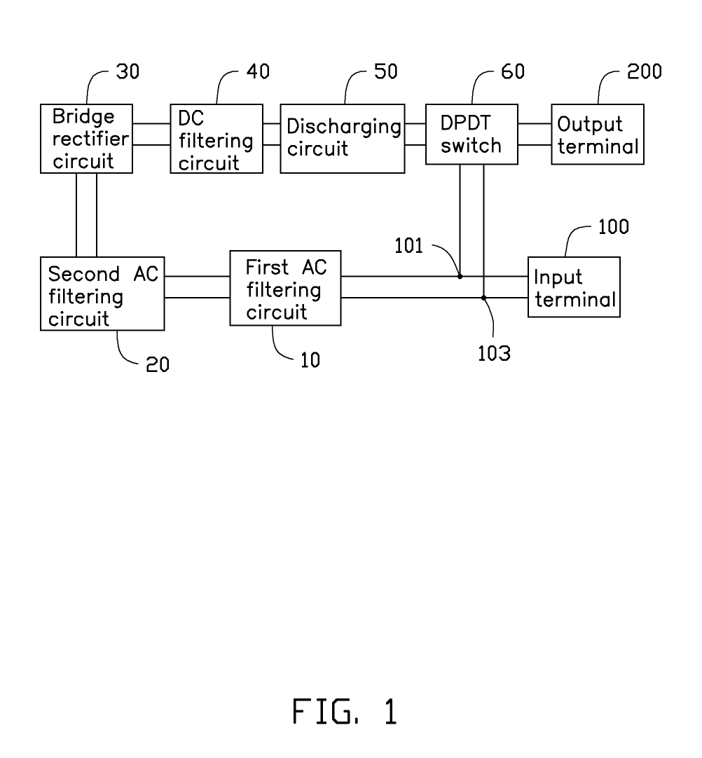

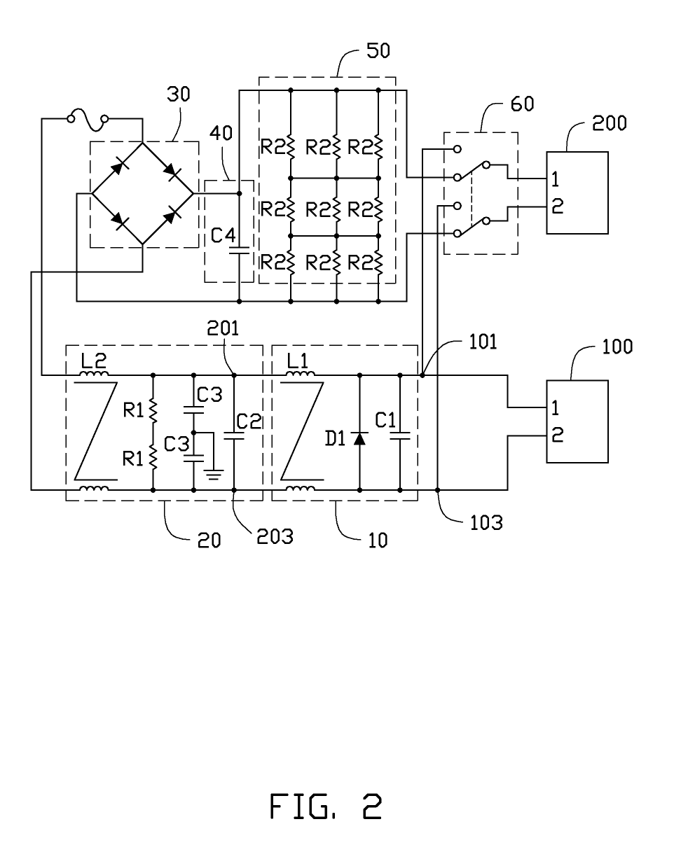

FIGS. 1 and 2, illustrate a power circuit according to one embodiment. The power circuit includes an input terminal 100 connected to alternating current. A first AC filtering circuit 10 is connected to the input terminal 100. A second AC filtering circuit 20 is connected to the first AC filtering circuit 10. A bridge rectifier circuit 30 is connected to the second AC filtering circuit 20. A DC filtering circuit 40 is connected to the bridge rectifier circuit 30. A discharging circuit 50 is connected to the DC filtering circuit 40. A double pole double throw (DPDT) switch 60 is connected to the discharging circuit 50, and an output terminal 200 is connected to the DPDT switch 60. The input terminal 100 is connected between the first node 101 and a second node 103. The first node 101 and the second node 103 are connected to the first pair of input pins of the DPDT switch 60. The second pair of input pins of the DPDT switch 60 is connected to the first node 101 and the second node 103. The pair of output pins of the DPDT switch 60 is connected to the output terminal 200.

The first AC filtering circuit 10 includes a capacitor C1, a diode D1, and a common mode inductor L1. The capacitor C1 is connected between the first node 101 and the second node 103. The negative pole of the diode D1 is connected to the first node 101, and the positive pole of the diode D1 is connected to the second node 103. The two terminals of the common mode inductor L1 are connected to the first node 101 and the second node 103. The other two terminals of the common mode inductor L1 are connected to the third node 201 and the fourth node 203. In one embodiment, the capacitor C1 is 470 nF, and the common mode inductor L1 is replaced with a capacitor.

The second AC filtering circuit 20 includes a capacitor C2, two capacitors C3, a common mode inductor L2, and two resistors R1. The capacitor C2 and two terminals of the common mode inductor L2 are connected to the third node 201 and the fourth node 203. One capacitor C3 has a terminal connected to the third node 201, and the other terminal connected to ground. The other capacitor C3 has a terminal connected to the fourth node 203, and the other terminal connected to ground. The two resistors R1 are connected between the third node 201 and the fourth node 203, in series. The other two terminals of the common mode inductor L2 are connected to the bridge rectifier circuit 30. In one embodiment, the capacitor C2 is 470 nF, the capacitor C3 is 3.3 nF, and the resistor R1 is 332 KΩ. In one embodiment, the common inductor L2 is replaced with a capacitor.

The bridge rectifier circuit 30 includes four diodes. The two input ends of the bridge rectifier circuit 30 are connected to the common mode inductor L2. The two output ends of the bridge rectifier circuit 30 are connected to the DC filtering circuit 40. The DC filtering circuit 40 includes a capacitor C4 connected between the two output ends of the bridge rectifier circuit 30. In one embodiment, the capacitor C4 is 120 μF.

The discharging circuit 50 includes nine resistors R2. The nine resistors R2 are divided into three groups. Each group includes three resistors R2 connected in parallel. The three groups are connected in series and are connected between the two output ends of the bridge rectifier circuit 30. In one embodiment, the resistor R2 is 10 kΩ, and the nine resistors R2 are replaced with one resistor.

The first AC filtering circuit 10 and the second filtering circuit 20 filter the alternating current when the input terminal 100 receives the alternating current. The filtered alternating current is converted to direct current by the bridge rectifier circuit 30. The DC filtering circuit 40 filters the direct current. When the second pair of input pins of the DPDT switch 60 is switched on. The direct current is transmitted to the output terminal 200. When the first pair of input pins of the DPDT switch 60 is switched on. The alternating current is transmitted to the output terminal 200. The discharging circuit 50 discharges direct current when the input terminal 100 receives no alternating current.

In one embodiment, a fuse is connected between the second AC filtering circuit 20 and the rectifier circuit 30.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A power circuit, comprising:
an input terminal configured to receive alternating current;
a first AC filtering circuit connected to the input terminal;
a bridge rectifier circuit, two input ends of the bridge rectifier circuit connected to the first AC filtering circuit;
a DC filtering circuit connected to two output ends of the bridge rectifier circuit;
a DPDT switch, the DPDT switch comprising a first pair of pins, a second pair of pins, and a pair of output pins, the first pair of pins connected to the DC filtering circuit, the second pair of pins connected to the input terminal; and
an output terminal connected to the pair of output pins of the DPDT switch;
wherein the first pair of pins is configured to be switched on to enable the output terminal to output direct current, and the second pair of pins is configured to be switched on to enable the output terminal to output alternating current.

2. The power circuit of claim 1, wherein the first AC filtering circuit comprising a capacitor, a diode, and a common mode inductor; the capacitor and the diode are both connected between the two terminals of the input terminal; and the common mode inductor is connected between the bridge rectifier circuit and the capacitor.

3. The power circuit of claim 1, further comprising a second AC filtering circuit, wherein the second AC filtering circuit comprises a first capacitor, two second capacitors, two resistor and a common mode inductor; first terminals of the two second capacitors are connected to two terminals of the first capacitor, and second terminals of the two second capacitors are connected to ground; the two resistors connected in series are connected between the two terminals of the first capacitor; and the common mode inductor is connected between the first capacitor and the bridge rectifier circuit.

4. The power circuit of claim 1, further comprising a discharging circuit connected between the DC filtering circuit and the DPDT switch.

5. The power circuit of claim 4, wherein the discharging circuit comprises a resistor connected to the DC filtering circuit.

6. The power circuit of claim 4, wherein the discharging circuit comprises a plurality of resistors; the plurality of resistors comprises a plurality of groups of resistors; and the plurality of groups of resistors are connected in series.

7. The power circuit of claim 1, wherein a fuse is connected between the first AC filtering circuit and the bridge rectifier circuit.
